(19) United States
(12) Patent Application Publication
(10) Pub. No.: US 2015/0217896 A1
(43) Pub. Date: Aug. 6, 2015

(54) PACKAGING MATERIALS DERIVED FROM RENEWABLE RESOURCES AND INCLUDING A CYCLODEXTRIN INCLUSION COMPLEX

(71) Applicant: CLEMSON UNIVERSITY, CLEMSON, SC (US)

(72) Inventors: Youngjae Byun, Central, SC (US); Young Teck Kim, Central, SC (US); Danny Roberts, Clemson, SC (US); Joseph D. Gangemi, Seneca, SC (US)

(21) Appl. No.: 14/641,612

(22) Filed: Mar. 9, 2015

Related U.S. Application Data
(63) Continuation of application No. 13/025,512, filed on Feb. 11, 2011.
(60) Provisional application No. 61/303,453, filed on Feb. 11, 2010.

(51) Int. Cl. B65D 1/40; B29C 45/00; B29C 47/00; B29C 49/00; B32B 27/36; B32B 27/08

(52) U.S. Cl. CPC B65D 1/40; B32B 27/36; B32B 27/08; B29C 47/0004; B29C 49/0005; B29C 45/0001; B32B 2250/02; B32B 2250/244; B32B 2307/7163; B32B 2439/02; B29K 2003/00; B29K 2033/00

(57) ABSTRACT

Disclosed are composite polymeric materials in which one or more polymers of the composite are incorporated into a cyclodextrin inclusion complex. Disclosed composite polymeric materials can exhibit improvements in thermal stability as compared to similar materials that do not utilize an inclusion complex in the formulation. In one embodiment, disclosed materials can be quickly composted and biodegraded to form environmentally innocuous components. Additionally, one or more polymers of a material can be derived from renewable resources. Disclosed materials can include additional additives such as nanoclays, inhibitory agents, natural fibers, and so forth and may be formed for use in any of a variety of packaging applications, e.g., injection blow molded packaging materials.

### CROSS REFERENCE TO RELATED APPLICATIONS

The present application is a continuing application and claims priority to U.S. patent application Ser. No. 13/025,512 having a filing date of Feb. 11, 2011, which claims filing benefit of U.S. Provisional Patent Application Ser. No. 61/303,453 having a filing date of Feb. 11, 2010, which is incorporated herein in its entirety by reference thereto.

### BACKGROUND

The production of plastics from renewable resources as well as the production of plastics that can biodegrade into innocuous components have been fields of increasing interest for many years. Several polymeric materials have shown promise including polylactides, polycaprolactones, and polyhydroxyalkanoates, just to name a few. For instance, the ring-opening polymerization of lactide has shown promise in production of biodegradable polymeric materials. Lactic acid-based materials are often of particular interest as the raw materials can be derived from renewable agricultural resources (e.g., corn, plant starches, and canes).

Various approaches have been taken in an attempt to obtain lactide-based polymeric materials having desired product characteristics. For example, U.S. Pat. No. 5,744,516 to Hashitani, et al., U.S. Pat. No. 6,150,438 to Shiraishi, et al., U.S. Pat. No. 6,756,428 to Denesuk, and U.S. Pat. No. 6,869,985 to Mohanty, et. al. all disclose various lactide-based polymers and methods of forming the lactide-based polymers.

While improvements have been made in the field and in particular with regard to the formation of lactide-based materials suitable for a variety of applications, room for improvement still remains. For instance, polylactide-based materials (PLA) have a relatively high glass transition temperature (T_{g}) in the range of 50-60° C. and low melting temperature (Tₘ) as compared to other thermoplastics Also, the low thermal stability of PLA creates limitations during commercialization. Specifically, high thermal stability is needed in the processing of PLA, such as film and sheet extrusion, blown film and foam products.

Attempts have been made to overcome such limitations through formation of blended compositions in which a polymer formed of renewable resources such as PLA is blended with a synthetic polymer that exhibits favorable physical characteristics but is derived from a non-renewable resource. Unfortunately, due to lack of miscibility between polymers, it has only been possible to form composite materials that include relatively small amounts of the environmentally friendly polymeric component, e.g., the PLA.

In addition to the need for improved products in terms of physical properties including thermal properties, strength characteristics, aesthetic characteristics, and the like, there is also a continuing need in the art to form more ecologically friendly products. For instance, methods and materials that could improve miscibility between polymers so as to maintain the desirable characteristics of a polymeric composite while increasing the proportion of environmentally friendly components in the composite would be of great benefit. It would also be beneficial to form products via methods requiring less energy input than required for current methods.

What are needed in the art are polymeric compositions that include polymers formed from renewable resources and/or polymers that can degrade into innocuous components that can exhibit good characteristics for use as packaging materials. For instance, packaging materials that can include polymers formed from renewable resources, that exhibit good thermal stability and that can be quickly degraded by natural biodegradation processes would be of great benefit.

### SUMMARY

According to one embodiment, disclosed is moldable polymeric composite material (i.e., a polymeric material that can be shaped and cured in a desired conformation) comprising a polymer and a cyclodextrin. More specifically, the polymer and the cyclodextrin form an inclusion complex in the material and the polymer is a renewable resource derived polymer, e.g., a lactic acid derived polymer or a polyhydroxy alkanoate.

In one embodiment, the cyclodextrin can be conjugated to another component of the material. For instance, the cyclodextrin can be a substituted cyclodextrin and can be conjugated to another component of the material via a crosslinking agent.

A composite material can include additional materials, for instance a composite material can include a second polymer that can be in a second inclusion complex, that can be conjugated to the first inclusion complex, or that can be blended with the other components of the composite.

Disclosed materials can include high percentages of a renewable resource derived material. For example, a composite material can include greater than about 50% by weight of the renewable resource derived polymer.

Also disclosed are molded containers formed of the composite materials. For instance, a molded container can include a layer formed of a composite material that includes a renewable resource derived polymer/cyclodextrin inclusion complex.

A container can be, e.g., an injection molded or blow molded container. In one embodiment, the layer of the container that includes the inclusion complex can be an extruded layer.

A container can include one or several layers. For instance, a container can include multiple layers that include a renewable resource derived polymericyclodextrin inclusion complex and/or traditional layers, e.g., a traditional liquid impermeable polymeric layer.

Also disclosed are method for forming the composite materials and the molded articles that can be formed form the materials.

### BRIEF DESCRIPTION OF THE DRAWING

A full and enabling disclosure of the present invention, including the best mode thereof, to one of ordinary skill in the art, is set forth more particularly in the remainder of the specification, including reference to the accompanying figures in which:

FIGS. 1A-1D illustrate the chemical structure of α-cyclodextrin (FIG. 1A), β-cyclodextrin (FIG. 1B), and γ-cyclodextrin (FIG. 10) and a modified β-cyclodextrin (FIG. 1D).

FIG. 2 illustrates the molecular dimensions of β-cyclodextrin.

FIGS. 3A-3C are schematic representations of components of a composite material as described herein.

FIGS. 4A and 4B are schematic representations of components of another composite material as described herein.

FIGS. 5A and 5B are schematic representations of components of another composite material as described herein,

FIGS. 6A and 6B illustrate two different formation schemes for exemplary conjugated inclusion complexes as disclosed herein.

FIG. 7 is a schematic representation of another composite material as described herein.

FIGS. 8A-8C schematically illustrate product formations as may incorporate materials as disclosed herein.

FIGS. 9A-9C illustrate the wide angle X-ray diffraction of components and inclusion complexes as described herein.

FIG. 10 is a scanning electron microscope (SEM) image of a material including polylactide (PLA)/β-cyclodextrin (β-CD) inclusion complex as described herein.

FIGS. 11A-11G are SEM images of PLA composite films as described herein.

FIG. 12 illustrates differential scanning calorimetry (DSC) thermograms of composite films as described herein.

FIG. 13 illustrates thermomechanical analysis (TMA) thermograms of composite materials as described herein.

### DETAILED DESCRIPTION OF REPRESENTATIVE EMBODIMENTS

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made to the disclosed subject matter without departing from the scope or spirit of the disclosure. For instance, features illustrated or described as part of one embodiment, may be used with another embodiment to yield a still further embodiment.

### Definitions

As utilized herein, the term “biodegradation” generally refers to the deterioration of a material due to the action of naturally occurring microorganisms.

As utilized herein, the term “biodegradable” generally refers to a material that achieves about 60% biodegradation within about 180 days under composting conditions of ASTM D6400.

As utilized herein, the term “compostable” generally refers to a material that achieves about 60% biodegradation within about 45 days under composting conditions of ASTM D6400.

As utilized herein, the term lactide-based polymer' is intended to be synonymous with the terms polylactide, polylactic acid and polylactide polymer, and is intended to include any polymer formed via the ring opening polymerization of lactide monomers as well as any polymer formed via the polycondensation of lactic acid monomers, either alone (i.e., homopolymer) or in mixture or copolymer with other monomers. The term is also intended to encompass any different configuration and arrangement of the constituent monomers (such as syndiotactic, isotactic, and the like). While a lactide-based polymer may be derived from a renewable resource in one preferred embodiment, this is not a requirement of disclosed composite materials.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Furthermore, any patent reference cited herein is hereby incorporated by reference in its entirety.

### DETAILED DESCRIPTION

In general, disclosed herein are composite polymeric materials in which one or more polymers of the composite are incorporated into a cyclodextrin inclusion complex. Disclosed composite polymeric materials can exhibit improvements in thermal stability as compared to similar materials that do not utilize an inclusion complex in the formulation. In one embodiment, disclosed materials can be quickly composted and biodegraded to form environmentally innocuous components. Additionally, one or more polymers of a material can be derived from renewable resources. Disclosed materials can be formed for use in any of a variety of packaging applications, e.g., injection blow molded packaging materials.

Cyclodextrins are cyclic oligosaccharides having a hydrophilic exterior and a hydrophobic central cavity. The hydrophobic central cavity of cyclodextrin is torus-shaped, and its molecular dimensions allow total or partial inclusion of guest compounds. An inclusion complex is defined when all or a portion of a guest molecule fits into the lattice of the larger cyclodextrin host molecule. Thus, all or a portion of the guest molecule can be encircled by the cavity of the cyclodextrin molecule.

The formation and stability of an inclusion complex can depend on the binding forces between the host cyclodextrin and the guest molecule. The binding forces include hydrogen bonds, Van der Waals forces, and dipole-dipole interactions, with no covalent bonds occurring between the host and guest during the formation of an inclusion complex. In general, an inclusion complex can be formed in an aqueous solution and the main driving force of complex formation will be the release of molecules from the cavity. Specifically, water molecules can be displaced by guest molecules. Generally, a guest molecule will be at least somewhat hydrophobic and displacement can occur to attain more favorable nonpolar-nonpolar association and to reach more stable energy states of components in the solution.

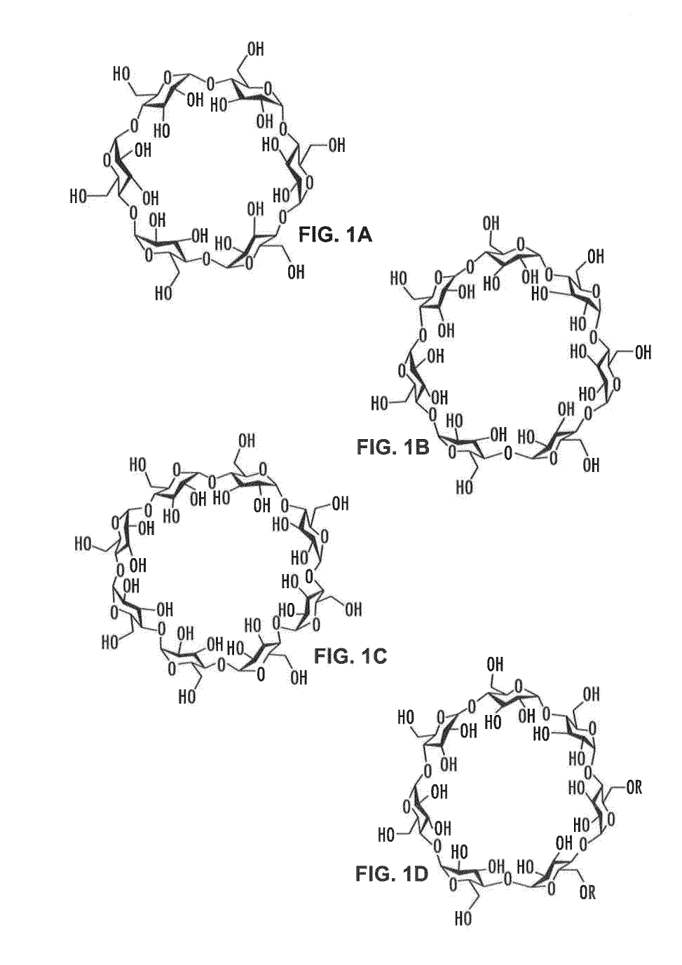

According to the present disclosure, a cyclodextrin (CD) can form an inclusion complex with a polymer and the polymer/CD inclusion complex can be a component of a composite polymeric formulation. In general, any size cyclodextrin can be utilized as disclosed herein. Commercially available cyclodextrins include 6, 7, or 8 glucopyranose units and are referred to α-, β-, and γ-cyclodextrin, as illustrated in FIGS. 1A-1C, respectively. The inner cavities of α-, β-, and γ-cyclodextrin have reported diameters of 5,7 Å, 7.8 Å, 9.5 Å, and volumes of 174 Å³, 262 Å³, and 427 Å³, respectively.

Additionally, it should be understood that the present disclosure encompasses modified cyclodextrin derivatives as are generally known in the art in addition to raw cyclodextrin. For instance, FIG. 1D illustrate a modified β-cyclodextrin in which one or more hydroxyl groups of the ring can be substituted to include any suitable R group including, without limitation, any straight or branched aliphatic or aromatic group. For instance, a cyclodextrin can be substituted with one or more groups including, without limitation, amine, alkylamine, acylamino, thio, ether, carbonyl, amide or ester moieties. Moreover, it should be understood that modification of a cyclodextrin component can take place either prior to or following formation of a cyclodextrin inclusion complex. For instance, an inclusion complex can be formed between a modified cyclodextrin and a polymer. In this embodiment a process can include the step of modifying the cyclodextrin prior to formation of the inclusion complex. Alternatively, an inclusion complex can be formed between an unmodified raw cyclodextrin and a polymer and following formation the cyclodextrin of the inclusion complex can be modified as desired.

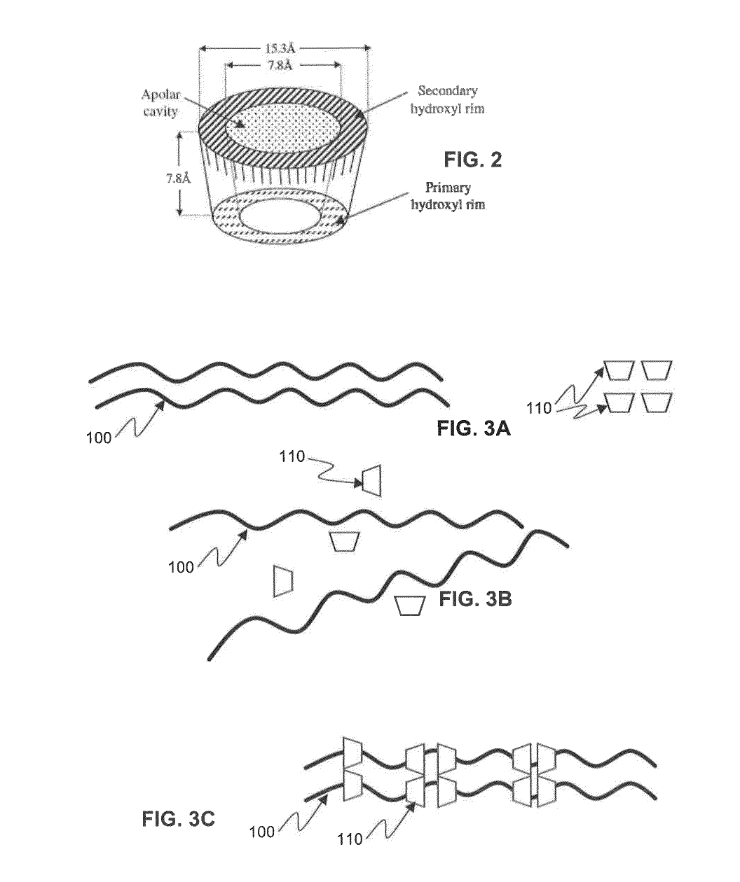

FIG. 2 illustrates the molecular dimensions of β-cyclodextrin. β-cyclodextrin can be preferred in one embodiment of disclosed systems due to cost considerations. However, while much of the following discussion is directed to β-cyclodextrins, it should be understood that disclosed systems and methods are in no way limited to β-cyclodextrin inclusion complexes. For instance, larger or smaller cyclodextrins can be preferred depending upon the size of guest molecule of the inclusion complex and/or favorable energy states of the system.

There is no particular limitation as to polymers that can be incorporated in disclosed composite systems, save that at least one of the polymers of a composite material can be incorporated in a cyclodextrin inclusion complex. In general, polymers of disclosed inclusion complexes can be amphiphilic or hydrophobic. In one embodiment, a polymer of an inclusion complex can be formed of a renewable resource, and in one preferred embodiment, can be a polylactide.

A lactide-based polymer of a composite material can be derived from lactic acid. Lactic acid is produced commercially by fermentation of agricultural products such as whey, corn, potatoes, molasses, and the like. Lactic acid-based polymers can be formed by direct polycondensation of lactic acid. Alternatively, a lactide monomer can first be formed by the dimerization of polycondensated lactic acid. Ring opening polymerization of lactide can then be used to form lactide-based polymers. In the past, production of lactide was a slow, expensive process, but advances in the art have enabled the production of high purity lactide at reasonable costs. Such as described in WO 07/047999A1 and U.S. Pat. No. 5,539,081.

In one embodiment, a composite material can include a PLA homopolymer formed exclusively from polymerization of lactide monomers. For example, D-lactide, L-lactide, meso-lactide, or racemic mixtures of lactide monomers can be polymerized in the presence of a suitable polymerization catalyst, generally at elevated heat and pressure conditions, as is generally known in the art. In general, the catalyst can be any compound or composition that is known to catalyze the polymerization of lactide. Such catalysts are well known, and include alkyl lithium salts and the like, stannous octoate, aluminum isopropoxide, and certain rare earth metal compounds as described in U.S. Pat. No. 5,028 667 to McLain, et. al. The particular amount of catalyst used can vary generally depending on the catalytic activity of the material, as well as the temperature of the process and the polymerization rate desired. Typical catalyst concentrations include molar ratios of lactide to catalyst of between about 10:1 and about 100,000:1, and in one embodiment from about 2,000:1 to about 10,000:1. According to one exemplary process, a catalyst can be distributed in a starting lactide monomer material. If a solid, the catalyst can have a relatively small particle size. In one embodiment, a catalyst can be added to a monomer solution as a dilute solution in an inert solvent, thereby facilitating handling of the catalyst and its even mixing throughout the monomer solution. In those embodiments in which the catalyst is a toxic material, the process can also include steps to remove catalyst from the mixture following the polymerization reaction, for instance one or more leaching steps.

A PLA polymerization process can generally be carried out at elevated temperature, for example, between about 950° C. and about 1200° C., or in one embodiment between about 1100° C. and about 1700° C., and in another embodiment between about 1400° C. and about 1600° C. The temperature can generally be selected so as to obtain a reasonable polymerization rate for the particular catalyst used while keeping the temperature low enough to avoid polymer decomposition. In one embodiment, polymerization can take place at elevated pressure, as is generally known in the art. The process typically takes between about 1 and about 72 hours, for example between about 1 and about 4 hours.

Polylactide homopolymer obtainable from commercial sources can also be utilized in forming the disclosed polymeric composite materials. For example, poly(L-lactic acid) available from Polysciences, Inc., Natureworks, LLC, Cargill, Inc., Mitsui (Japan), Shimadzu (Japan), or Chronopol can be utilized in the disclosed methods.

A lactide-based polymer matrix can include co-polymers formed from a lactide monomer or oligomer in combination with one or more other monomeric or polymeric materials. For example, in one embodiment, lactide can be co-polymerized with one or more other monomers or oligomers derived from renewable resources to form a lactide-based copolymer that can be incorporated in a polymeric composite material. A secondary component of a copolymer can be a material that can be least recyclable and, in one embodiment, completely and safely biodegradable so as to present no hazardous waste issues upon degradation of the copolymer. In one particular embodiment, a lactide monomer can be co-polymerized with a monomer or oligomer that is anaerobically recyclable, which can improve certain characteristics of the copolymer as compared to that of a PLA homopolymer. Polylactide copolymers for use in the disclosed composite materials can be random copolymers or block copolymers, as desired.

A PLA polymer can also be combined with another polymer in a blend, rather than in a copolymerization. For instance, a composite material can include a PLA blended with one or more additional polymers that may in turn be formed of a renewable resource. Blends including one or more polymers derived from nonrenewable resources are also encompassed herein.

In another embodiment, disclosed composite materials need not include a PLA component, and can include a different polymer formed of renewable resources, optionally in combination with one or more additional polymers. By way of example, other polymers formed of renewable resources as may be incorporated in disclosed composite materials can include, without limitation, polyhydroxy alkanoate (PHA), poly(trimethylene terephthalate) (PTT), polycaprolactone (PCL), polyamides, and so forth.

PHAs are a class of biopolymers that are produced in nature by bacterial fermentation of sugars or lipids. Various microorganisms including Raistonia eutropha, Alcalgenes latus, and Pseudomonas sp. have been reported to produce PHAs by the condensation or modification of acetyl-CoAs.

There are many different polymers and copolymers within the general PHA family that can be incorporated into a composite polymeric material, for instance in the cyclodextrin inclusion complex. Accordingly, products can have a wide range of properties. For example, as PHA polymers can be thermoplastic and elastomeric, and can describe melting temperatures anywhere between about 40° C. and 180° C. prior to formation of an inclusion complex. A polymeric product including a PHA polymer or copolymer can likewise describe a wide range of characteristics. PHAs have attracted a great deal of attention not only due to their anaerobic biodegradable nature, but also due to the high degree of crystallinity and well-defined melt temperatures that are attainable for certain members of the class.

Disclosed materials can incorporate a poly(trimethylene terephthalate) formed from a propane diol that can be formed from a variety of renewable resources, such as corn. A final PTT polymer can generally have a renewable content of 30-37%.

FIG. 3A schematically illustrates components of a polymericyclodextrin inclusion complex as described herein including a polymer component 100 and a cyclodextrin component 110. As shown in FIG. 3B, the separate components can be simply mixed together to form a blend. However, in disclosed materials, a polymer 100 can be incorporated within the lattice of a cyclodextrin 110 to form an inclusion complex, as shown in FIG. 3C. In addition, it is believe that a single polymer 100 can be incorporated within the lattice of several individual cyclodextrin molecules 110, as shown.

While not wishing to be bound by any particular theory, it is believed that the formation of a polymer/CD inclusion complex can improve various physical characteristics of a formed polymeric material because the inclusion complex hinders various aspects of the polymer. For instance, an inclusion complex as illustrated in FIG. 3C is understood to hinder molecular motion of the polymer, which can translate into an increase in the glass transition temperature (T_{g}) of the polymer and the polymeric material incorporating the inclusion complex. An inclusion complex can also hinder change in the crystalline structure of the material, which can lead to a decrease in the crystallization temperature (T_{c}) of the polymer.

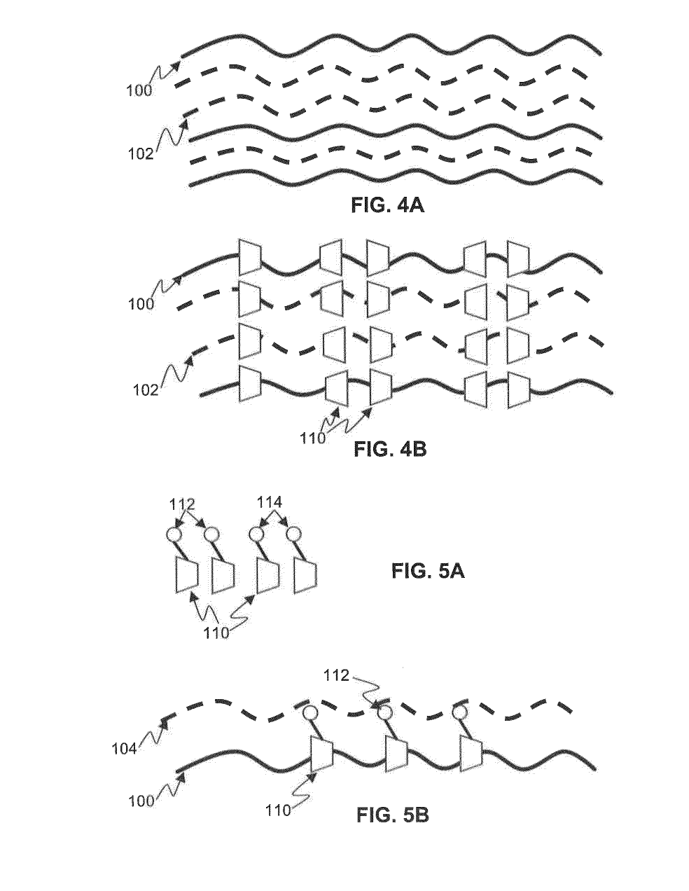

As previously mentioned, disclosed composite materials can include multiple polymers in the composite. Beneficially, incorporation of a polymer in a cyclodextrin inclusion complex can also increase the miscibility of different polymers in a composite material. For instance, and as schematically illustrated in FIG. 4A, PLA-based materials often include a blend of PLA 100 with another polymer 102 so as to improve the physical characteristics of the composite material as compared to a pure PLA material. For instance, PLA 100 may be blended with a polymer 102 that can be a recyclable polymer such as polyolefins (e.g., polyethylene, low density polyethylene (LDPE), polypropylene, and copolymers thereof), polyesters such as polyethylene terephthalate, polystyrene, polyvinylchloride, polyurethanes, or the like. A composite material can include a blend of polymers formed of renewable as well as nonrenewable resources as well as biodegradable polymers (e.g., gelatin, starch, polyhydroxyalkanoate (PHA), biopolymers, etc.).

The relative proportions of polymers included in a blend can generally depend upon the desired physical characteristics of the polymeric products that can be formed from the composite materials. However, in the past, due to miscibility problems between PLA and other polymers, the PLA component has been limited to incorporation in the composite at a concentration of less than about 20% by weight of the composition.

FIG. 4B illustrates one embodiment of the present disclosure in which the multiple polymer components of a blend are each incorporated in CD inclusion complexes. As illustrated, a polymer derived from a renewable resource, such as PLA 100 can be incorporated with cyclodextrin 110 to form PLA/CD inclusion complexes, as can a second polymer 102. This can improve miscibility of the two polymers 100, 102, and can provide a route for incorporation of a much higher concentration of PLA in a composite material than previously possible. For example, a polymer/CD inclusion complex blend can include a polymer derived from a renewable resource in an amount greater than about 50% by weight of the polymer blend. In another embodiment, a polymeric blend can include at least about 70% renewable resource polymer by weight of the blend, or higher in other embodiments, for instance greater than about 80% of the renewable resource polymer by weight of the blend.

A cyclodextrin inclusion complex including a polymer in the inclusion complex can be formed through combination of the components under suitable formation conditions. For instance, an aqueous solution including cyclodextrin can be formed and combined with a polymer. Depending upon the characteristics of the polymer, it can be directly combined with an aqueous solution of cyclodextrin or alternatively presented as an organic solution in which the organic solvent is miscible in an aqueous solution. The solution can be heated and/or stirred according to known practices to encourage formation of the inclusion complex.

According to another embodiment, not all of the polymers of a polymer blend need be incorporated into an inclusion complex. For instance, a PLA/CD inclusion complex can be blended with another polymer that is not incorporated in a CD inclusion complex.

As previously mentioned, encompassed herein are modified cyclodextrins. For instance, and as illustrated in FIG. 5A, the cyclodextrin 110 of a system can be functionalized with one or more reactive moities, 112, 114. The cyclodextrin of an inclusion complex can be functionalized either prior to or following formation of an inclusion complex. In one embodiment, a modified cyclodextrin can conjugate with other components of a composite material. Conjugation between components of a composite can include covalent and noncovalent bonding, e.g., ionic bonding, hydrogen bonding, charge-charge interaction, and so forth.

Desired functionalization moieties of a cyclodextrin can depend upon the desired characteristics of the composite materials. In one embodiment, a functionalized cyclodextrin can be designed to conjugate with a secondary material of the composite. For instance, as illustrated in FIG. 5B, a first polymer 100 can be incorporated within a cyclodextrin 110 to form a polymer/CD inclusion complex. In addition, the cyclodextrin 110 of the inclusion complex can be can be functionalized with a reactive moiety 112 that can bond a second polymer 104 of the composite material. This can provide additional benefit to a composite. For instance, binding between a cyclodextrin and a second polymer of a system can further increase the miscibility of the polymers 110, 104 of a composite.

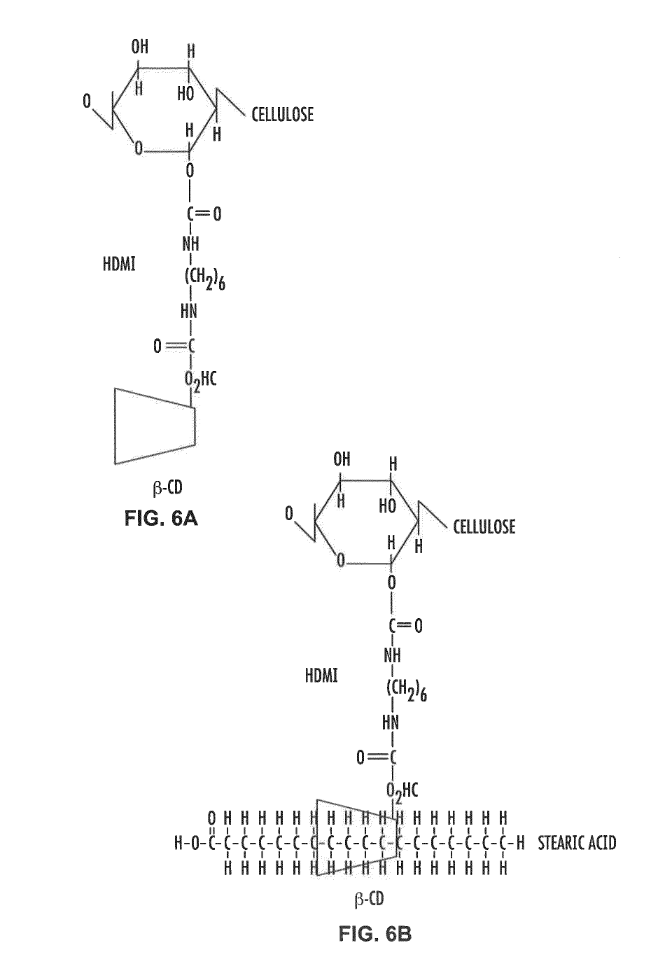

A component of a composite material can be conjugated to a cyclodextrin according to any known standard methodology and at any time during a formation process. For instance, FIG. 6A illustrates one formation process in which a β-cyclodextrin is bonded to cellulose via a hexamethylene diisocyanate (HDMI) connecting arm. According to this embodiment, a cyclodextrin/polymer inclusion complex can be formed subsequent to the conjugation step. For instance, the crosslinking agent can bond the cyclodextrin via the anhydride of the crosslinker at suitable reaction conditions. Following, the conjugation reaction can occur by dehydration of a mixture including the cellulose polymer and the functionalized cyclodextrin below the curing temperature of the crosslinking agent, which can form a second anhydride that can react with a cellulosic unit from the macromolecular chain. In another embodiment, illustrated in FIG. 6B, an inclusion complex can be formed between β-cyclodextrin and an additive (e.g., a fatty acid additive such as palmitic or stearic acid, or a was such as beeswax or carnauba) followed by conjugation of the inclusion complex to cellulose via the crosslinking agent, e.g., HMI. As can be seen in the figures, a cyclodextrin can be conjugated to a component of the polymeric material that is external to the cyclodextrin torroid. As previously described, an inclusion complex is defined when all or a portion of a guest molecule fits into the lattice of the larger cyclodextrin host molecule, with no covalent bonding between the cyclodextrin and the guest molecule. In contrast, a modified cyclodextrin can conjugate with an external compound via covalent or non-covalent bonding, and the conjugated compound is not within the lattice of the cyclodextrin, but is rather external to the cyclodextrin. Thus, a polymeric material can include the cyciodextrin inclusion complex conjugated with another component of the material.

A component can be conjugated to a cyclodextrin according to any suitable process. In one embodiment, a hydroxyl group of the cyclodextrin can be substituted with a desired functional group, for instance via protonation of the hydroxyl group, followed by nucleophilic substitution, dehydration, esterification, oxidation, or any other suitable chemistry to form a reactive moiety on a cyclodextrin that can then be utilized to conjugate a component of the composite material to the cyclodextrin.

A cyclodextrin can be functionalized to include a connecting arm that can be reactive to another component of a composite material. By way of example, a cyclodextrin can include a connecting arm having a structure of, but not limited to, CH_{2(CH}₂)ₙ, CH₂X(CH₂)ₙ, CH₂X—(CH₂)ₙ—XCH₂, CH₂X—(CH₂)ₙ—(O)XCH₂, CH₂X—C(O)(CH₂)ₙ—XCH₂, CH₂X—Ar—XCH₂, CH₂X—(CH₂)ₙ—Ar—XCH₂, CH₂X—Ar—(CH₂)ₙ—XCH₂, CH₂X—(CH₂)ₙ—(CH₂)ₙ—XCH, CH₂X—Ar—C(O)XCH₂, CH₂X—(CH₂)ₙ—Ar—C(O)XCH₂, CH₂X—Ar—(CH₂)ₙ—C(O)XCH₂, CH₂X—(CH₂)ₙ—Ar—(CH₂)ₙ—C(O)XCH₂, CH₂XC(O)—Ar—XCH₂, CH₂XC(O)—(CH₂)ₙ—Ar—XCH₂, CH₂XC(O)—Ar—(CH₂)ₓ—XCH₂ and CH₂XC(O)—(CH₂)ₓ—Ar—(CH₂)—XCH₂. Wherein n is an integer of between 1 and 10, X is a member selected from the group consisting of O, S, or NR where R is H or alkyl, aralkyl, aryl or alkaryl, Ar, aryl and the aryl portions of alkaryl and aralkyl represents an aromatic ring selected from the group consisting of benzene, thiophene, furan, pyridine, pyrrole, imidazole, oxazole, thiazole, pyrazole and pyrimidine rings and, even though not an aromatic ring, Ar can also represent a cyclohexane ring. The linkages to the aromatic ring can be in the 2,3, 2,4 or 2,5 positions on a five membered ring or in the o, m or p- positions on a six member ring. The CeHio (cyclohexylene) moiety can be linked in the 1,2, 1,3 and 1,4 positions. The (CH₂)ₙ moiety is meant to represent any alkylene moiety including both straight or branched chain forms having a 2:1 hydrogen to carbon ratio. The term alkyl, or the alkyl portions of the aralkyl and alkaryl groups can contain from 1 to 10 carbon atoms and be either straight or branch chained.

Such connection arms have been described by Bradshaw, et al. (U.S. Pat. No. 5,403,898) in forming a cyclodextrin polysiloxane polymer, but these connecting arms are not limited to interaction with polysiloxanes, and may be utilized for bonding a functionalized cyclodextrin with any other suitable polymer in formation of a composite material.

In one embodiment, a cyclodextrin can be functionalized with a linker that can be bonded to a polymer and to the cyclodextrin via a bonding members. For instance, the linker can have the general structure of Q-Z-Q′ where Q is bonded to a polymer and Q′ is bonded to a cyclodextrin. Q and Q′ can be independently selected from NR, S, O, CO, CONH, and COO. For instance, Q and Q′ can include amine, alkylamine, acylamine, thio, ether, carbonyl, amide or ester moieties. Z can be, without limitation, alkylene disulfide, alkylene, alkylene oxide, or a short chained peptide. In one preferred embodiment, Q can be attached to a derivatized polymer chain through an alkylene group. In one preferred embodiment, the linker can be biodegradable. R can be H, alkyl, alkenyl or acyl. Examples of such derivatized cyclodextrins are known in the art and have been described. See, for example, U.S. Pat. No. 7,141,540 to Wang, et al.

Other materials can be conjugated with a polymer/CD inclusion complex, in addition to or instead of a second matrix polymer. For instance, an additive to the composite material that can be polymeric or nonpolymeric, as desired, can be conjugated to the cyclodextrin of a polymer/CD inclusion complex. A secondary material can be conjugated to a cyclodextrin either prior to or subsequent to the formation of the inclusion complex. By way of example, a naturally derived oil, a fatty acid, or a waxy ester can be conjugated to a polymer/CD inclusion complex. Such methods can provide a route for increasing the loading level of one or more additives in the composite materials.

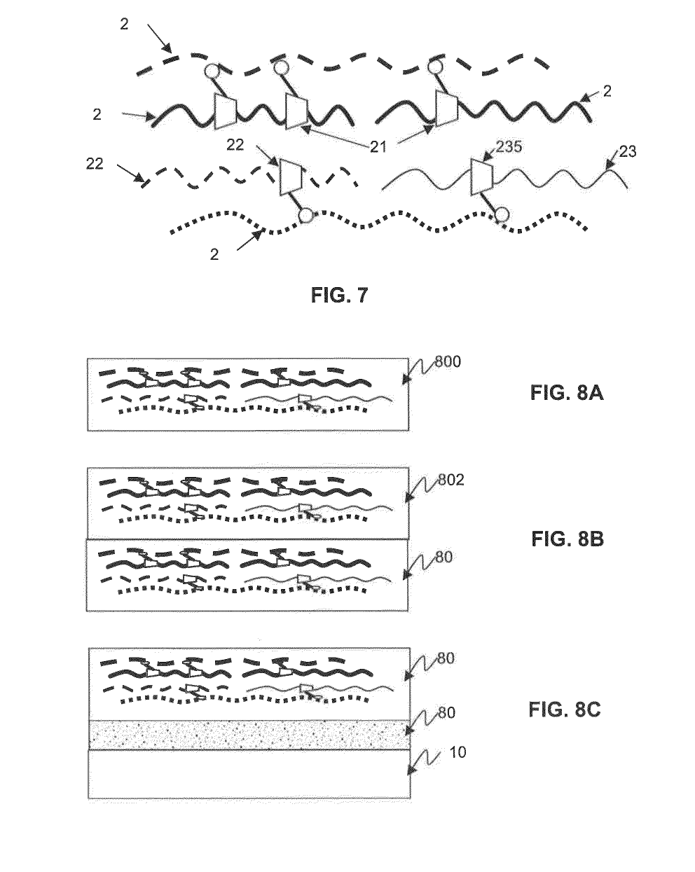

In one embodiment, a composite material can include multiple materials conjugated to one or more different polymer/CD inclusion complexes of the material. FIG. 7 schematically illustrates one such embodiment. As can be seen, a composite can include a polymer 210 complexed with a modified cyclodextrin 215 to form an inclusion complex. The cyclodextrin 215 can be modified to conjugate with another component 200 of the composite, e.g., a second polymer. The composite material can further include a polymer 220 incorporated in an inclusion complex with modified cyclodextrin 225 and a polymer 230 incorporated in an inclusion complex with modified cyclodextrin 235. Modified cyclodextrin 225 and modified cyclodextrin 235 can both conjugate with another additive 240. As can be seen, multiple different types of functionalized cyclodextrins can be utilized in forming inclusion complexes with one or more different components of a composite materials. Composite materials can also include one or more additional additives that can be merely blended with the inclusion complexes. Thus, disclosed materials can incorporate high loading levels of polymeric as well as non-polymeric components.

Grafting between a cyclodextrin component and another component can be carried out by use of any suitable bond formation chemistry. For instance, a cyclodextrin can be crosslinked to another component of a composite with any monomeric or polymeric crosslinking agent as is generally known in the art. Suitable crosslinking agents, for instance, may include polyglycidyl ethers, such as ethylene glycol diglycidyl ether and polyethylene glycol dicglycidyl ether; acrylamides; compounds containing one or more hydrolyzable groups, such as alkoxy groups (e.g., methoxy, ethoxy and propoxy); alkoxyalkoxy groups (e.g., methoxyethoxy, ethoxyethoxy and methoxypropoxy); acyloxy groups (e.g., acetoxy and octanoyloxy); ketoxime groups (e.g., dimethylketoxime, methylketoxime and methylethylketoxime); alkenyloxy groups (e.g., vinyloxy, isopropenyloxy, and 1-ethyl-2-methylvinyloxy); amino groups (e.g., dimethylamino, diethylamine and butylamino); aminoxy groups (e.g., dimethylaminoxy and diethylaminoxy); and amide groups (e.g., N-methylacetamide and N-ethylacetamide). Examples of crosslinking agents can include HDMI, epichlorohydrin, polycarboxylic acids, and the like.

Any of a variety of different crosslinking mechanisms may be employed in the disclosed composites, such as thermal initiation (e.g., condensation reactions, addition reactions, etc.), electromagnetic radiation, and so forth. Some suitable examples of electromagnetic radiation that may be used include, but are not limited to, electron beam radiation, natural and artificial radio isotopes (e.g., α, β, and γ rays), x-rays, neutron beams, positively-charged beams, laser beams, ultraviolet, etc. Electron beam radiation, for instance, involves the production of accelerated electrons by an electron beam device. Electron beam devices are generally well known in the art. For instance, in one embodiment, an electron beam device may be used that is available from Energy Sciences, Inc., of Woburn, Mass. under the name “Microbeam LV.” Other examples of suitable electron beam devices are described in U.S. Pat. Nos. 5,003,178 to Livesay; 5,962,995 to Avnery; 6407492 to Avnery, et al., which are incorporated herein in their entirety by reference thereto. The wavelength λ of the radiation may vary for different types of radiation of the electromagnetic radiation spectrum, such as from about 10⁻¹⁴ meters to about 10⁻⁵ meters. Electron beam radiation, for instance, has a wavelength λ of from about 10⁻¹³ meters to about 10⁻⁹ meters. Besides selecting the particular wavelength λ of the electromagnetic radiation, other parameters may also be selected to control the degree of crosslinking. For example, the dosage may range from about 0.1 megarads (Mrads) to about 10 Mrads, and in some embodiments, from about 1 Mrads to about 5 Mrads.

The source of electromagnetic radiation may be any radiation source known to those of ordinary skill in the art. For example, an excimer lamp or a mercury lamp with a D-bulb may be used. Other specialty-doped lamps that emit radiation at a fairly narrow emission peak may be used with photoinitiators which have an equivalent absorption maximum. For example, the V-bulb, available from Fusion Systems, is another suitable lamp for use. In addition, specialty lamps having a specific emission band may be manufactured for use with one or more specific photoinitiators.

Initiators may be employed in some embodiments that enhance the functionality of the selected crosslinking technique. Thermal initiators, for instance, may be employed in certain embodiments, such as azo, peroxide, persulfate, and redox initiators. Representative examples of suitable thermal initiators include azo initiators such as 2,2′-azobis(2,4-dimethylvaleronitrile), 2,2′-azobis(isobutyronitrile), 2,2′-azobis-2-methylbutyronitrile, 1,1′-azobis(1-cyclohexanecarbonitrile), 2,2′-azobis(methyl isobutyrate), 2,2′-azobis(2-amidinopropane) dihydrochloride, and 2,2′-azobis(4-methoxy-2,4-dimethylvaleronitrile); peroxide initiators such as benzoyl peroxide, acetyl peroxide, lauroyl peroxide, decanoyl peroxide, dicetyl peroxydicarbonate, di(4-t-butylcyclohexyl) peroxydicarbonate, di(2-ethylhexyl) peroxydicarbonate, t-butylperoxypivalate, t-butylperoxy-2-ethylhexanoate, and dicumyl peroxide; persulfate initiators such as potassium persulfate, sodium persulfate, and ammonium persulfate; redox (oxidation-reduction) initiators such as combinations of the above persulfate initiators with reducing agents such as sodium metabisulfite and sodium bisulfite, systems based on organic peroxides and tertiary amines, and systems based on organic hydroperoxides and transition metals; other initiators such as pinacols; and the like (and mixtures thereof). Azo compounds and peroxides are generally preferred. Photoinitiators may likewise be employed, such as substituted acetophenones, such as benzyl dimethyl ketal and 1-hydroxycyclohexyl phenyl ketone; substituted alpha-ketols, such as 2-methyl-2-hydroxypropiophenone; benzoin ethers, such as benzoin methyl ether and benzoin isopropyl ether; substituted benzoin ethers, such as anisoin methyl ether; aromatic sulfonyl chlorides; photoactive oximes; and so forth (and mixtures thereof). Other suitable photoinitiators may be described in U.S. Pat. No. 6,486,227 to Nohr, et al, and U.S. Pat. No. 6,780,896 to MacDonald, et al., both of which are incorporated herein by reference. Additives which may be included in disclosed composite materials include, but are not necessarily limited to, fillers, pigments, dyestuffs, stabilizers, processing aids, plasticizers, fire retardants, anti-fog agents, etc.

Disclosed composite materials can include one or more additives to further enhance characteristics of a product. For instance, in addition to a polymer/CD inclusion complex, disclosed composite materials can also include a plurality of natural fibers that can be derived from renewable resources and can be biodegradable. Fibers of a composite materials can, in one embodiment, reinforce mechanical characteristics of the composite materials. For instance fibers can improve the strength characteristics of the materials. The natural fibers can offer other/additional benefits to the disclosed composites, such as improved compatibility with secondary materials, improved biodegradability of the composite materials, attainment of particular aesthetic characteristics, and the like.

Natural fibers suitable for use in the presently disclosed composites can include plant, mineral, and animal-derived fibers. Plant derived fibers can include seed fibers and multi-cellular fibers which can further be classified as bast, leaf, and fruit fibers. Plant fibers that can be included in the disclosed composites can include cellulose materials derived from agricultural products including both wood and non-wood products. For example, fibrous materials suitable for use in the disclosed composites can include plant fibers derived from families including, but not limited to dicots such as members of the Linaceae (e.g., flax), Urticaceae, Tiliaceae (e.g., jute), Fabaceae, Cannabaceae, Apocynaceae, and Phytolaccaceae families, and, in some embodiments, monocots such as those of the Agavaceae family,

In one embodiment, the fibers can be derived from plants of the Maivaceae family, and in one particular embodiment, those of the genera Hibisceae (e.g., kenaf, beach hibiscus, rosselle) and/or those of the genera Gossypieae (e.g., cottons and allies). Other examples are mycelia fibers of species such as Tratnetes versicolor may be used.

In one embodiment, cotton fibers can be utilized in the disclosed composites. In general, cotton fibers can first be separated from the seed and subjected to several mechanical processing steps as are generally known to those of skill in the art to obtain a fibrous material for inclusion in a composite. In another embodiment, cotton flock which has a reduced length and have average fiber lengths from 350 μ to 1000 μ may be used.

In another embodiment, flax fibers can be incorporated into the disclosed composites. Processed flax fibers can generally range in length from 0.5 to 36 microns with a diameter from 12-16 micrometers, Linseed, which is flax grown specifically for oil, has a well established market and millions of acres of flaxseed are grown annually for this application, with the agricultural fiber residue unused. Thus, agricultural production of flax has the potential to provide dual cropping, jobs at fiber processing facilities, and a value added crop in rotation.

In another embodiment, natural protein-based fibers can be used. Exemplary fibers may include silk or spider silk and derivatives thereof. Such protein-based fibers may enhance structural stability. Additionally, the fibers may be in a crude form, i.e., protein-based fibers from the cocoons of worms, bees or other insects.

Reinforcement fibers of a composite material can include bast and/or stem fibers extracted from plants according to methods generally known in the art. According to such embodiments, the inner pulp of a plant can be a useful byproduct of the disclosed methods, as the pulp can beneficially be utilized in many known secondary applications, for instance in paper-making processes. For instance, the fibrous reinforcement materials can include bast fibers of up to about 10 mm in length. For example, kenaf bast fibers between about 2 mm and about 6 mm in length can be utilized as reinforcement fibers.

A composite polymeric material can generally include a fibrous component in an amount of up to about 50 percent by weight of the composite. For example, a composite material can include a fibrous component in an amount between about 10 percent and about 40 percent by weight of the composite.

According to one embodiment, the fiber component of the composite materials can serve merely to provide reinforcement to the polymeric matrix and improve strength characteristics of the material. In other embodiments, the fibrous component can optionally or additionally provide particular aesthetic qualities to the composite material and/or products formed therefrom. For example, particular fibers or combinations of fibers can be included in a composite material to affect the opacity, color, texture, plasticity, and overall appearance of the material and/or products formed therefrom. For instance, cotton, kenaf, flax, as well as other natural fibers can be included in the disclosed composites either alone or in combination with one another to provide a composite material having a unique appearance and/or texture for any of a variety of applications.

Composite materials can optionally include a nanoclay. Nanoclays are nanosized particles that are smaller than 100 nanometers (nm), namely particles that are small than 0.1 μm in any one direction. Exemplary materials include montmorillonite, pyrophyllite, hectorite, vermiculite, beidilite, seponite, kaolinites, and micas. The nanoclays may be naturally-or synthetically-derived, and can be intercalated or exfoliated. An exemplary natural nanoclay is available from Southern Clay Products. The composite polymer material may include between about 0.1 and about 15 percent by weight of a nanoclay.

A naturally-derived oil, fatty acid, or waxy ester can also be included in a composite polymer material. Such substances can provide water and gas barrier properties as well as enhanced thermoplastic properties for extrusion of composite polymer materials. The term “naturally-derived oil” refers to any triglyceride derived from a renewable resource, such as plant material. Natural long chain fatty acids and waxes include natural secretions of plants or animals such as various vegetable oils and their purified forms, e.g., beeswax and carnauba (a plant epicuticular wax). Exemplary naturally-derived oils can include without limitation one or more coffee oil, soybean oil, safflower oil, tong oil, tall oil, calendula, rapeseed oil, peanut oil, linseed oil, sesame oil, olive oil, dehydrated castor oil, tallow oil, sunflower oil, cottonseed oil, corn oil, coconut oil, palm oil, canola oil, and mixtures thereof. Exemplary fatty acids are long chained saturated and unsaturated fatty acids. Fatty acids include aliphatic monocarboxylic acids derived from or contained in esterified animal or vegetable fat, oil, or wax. Natural fatty acids generally have a chain of 4 to 28 carbons that may be saturated or unsaturated. Disclosed composites incorporate natural as well as synthetic fatty acids.

As utilized herein, the term ‘waxy esters’ generally refers to esters of long-chain fatty alcohols with long-chain fatty acids. Chain lengths of the fatty alcohol and fatty acid components of a waxy ester can vary, though in general, a waxy ester can include greater than about 20 carbons total. Waxy esters can generally exhibit a higher melting point than that of fats and oils. For instance, waxy esters can generally exhibit a melting point greater than about 45° C. Additionally, waxy esters encompassed herein include any waxy ester including saturated or unsaturated, branched or straight chained, and so forth. Exemplary naturally-derived waxy esters can include without limitation, beeswax, jojoba oil, plant-based waxes, bird waxes, non-bee insect waxes, and microbial waxes. By way of example, a composite material composition may include between about 0.1 and about 10 percent by weight of a naturally-derived oil, fatty acid, or waxy ester,

In one embodiment, disclosed composite materials can include a beeswax additive. Beeswax is a natural wax produced in the beehive of honey bees of the genus Apis. The main components of beeswax include palmitate, palmitoleate, hydroxypalmitate, oleate esters of aliphatic alcohols, and a 6:1 ratio of triacontanylpalmitate to serotic acid.

It is recognized by those skilled in the art that the naturally-derived oils, fatty acids, or waxy esters can be blended together or can be blended or replaced by synthetic equivalents.

A polymeric composite material can include one or more inhibitory agents. For example, a composite can include one or more natural and/or biodegradable agents that can be derived from renewable resources such as anti-oxidants, antimicrobial agents, anti-fungal agents, ultra-violet blockers, ultra-violet absorbers, scavenging agents including free radical scavenging agents, and the like that can be completely and safely biodegradable. In one exemplary embodiment, one or more inhibitory agents can improve protection of materials on one side of the formed polymeric material from one or more potentially damaging factors. For instance, one or more inhibitory agents can provide increased prevention of the passage of potentially harmful factors (e.g., oxygen, microbes, UV light, etc.) across a structure formed of the composite material and thus offer improved protection of materials held on one side of the composite polymeric material from damage or degradation. In one embodiment, a composite polymeric material can be designed to release an inhibitory agent from the matrix as the composite degrades, at which time the inhibitory agent can provide the desired activity, e.g., anti-microbial activity, at a surface of the polymeric composite.

Exemplary inhibitory agents can include without limitation, one or more natural anti-oxidants such as turmeric, burdock, green tea, garlic, ginger, astaxanthum, chlorophylinn, chlorella, pomegranate, acai, bilberry, elderberry, ginkgo biloba, grape seed, milk thistle, lutein (an extract of egg yolks, corn, broccoli, cabbage, lettuce, and other fruits and vegetables), olive leaf, rosemary, hawthorn berries, chickweed, capsicum (cayenne), and blueberry pulp, extractives, and derivates thereof. In one embodiment, the antioxidant is turmeric or a turmeric derivative. An exemplary turmeric is available from Natural Products Innovations, LLC as SKO1BDA. In another embodiment, the antioxidant is a source of polyphenols such as plant-derived polyphenols from green tea leaves.

One or more natural anti-microbial agents can be included in a polymeric composite. For example, exemplary natural anti-microbial agents can include berberine, an herbal anti-microbial agent that can be extracted from plants such as goldenseal, coptis, barberry, Oregon grape, and yerba mensa. Other natural anti-microbial agents can include, but are not limited to, extracts of propolis, St. John's wort, cranberry, garlic, E. cochinchinensis and S. officinalis, as well as anti-microbial essential oils, such as those that can be obtained from cinnamon, clove, or allspice, and anti-microbial gum resins, such as those obtained from myrrh and guggul.

Other exemplary inhibitory agents that can be included in the composite materials can include natural anti-fungal agents such as, for example, tea tree oil and resveratrol (a phytoestrogen found in grapes and other crops), or naturally occurring ultraviolet light blocking compounds such as mycosporine-like amino acids found in coral.

Optionally, the composite polymeric materials can include multiple inhibitory agents, each of which can bring one or more desired protective capacities to the composite.

In general, an inhibitory agent such as those described above can be included in an amount of about 0.1 to about 10 percent by weight of the composite material. In other embodiments, an agent can be included at higher weight percentage. In one embodiment, the preferred addition amount can depend on one or more of the activity level of the agents upon potentially damaging factors, the amount of material to be protected by a structure formed including the composite material, the expected storage life of the material to be protected, and the like. For example, in one embodiment, an inhibitory agent can be incorporated into a composite polymeric material in an amount of between about 1 μg/mL material to be protected/month of storage life to about 100 μg/mL material to be protected/month of storage life.

Beneficially, formation processes using disclosed composite polymeric materials can be carried out at low processing temperatures and as such, many natural inhibitory agents can be successfully incorporated in the composite materials. In particular, inhibitory agents in which the desired activity could be destroyed during the high-temperature processing conditions necessary for many previously known composite materials can be successfully included in the disclosed materials as they can maintain the desired activity throughout the formation processes.

A composite polymeric material can optionally include one or more additional additives as are generally known in the art. For example, a small amount (e.g., less than about 5 percent by weight of the composite material) of any or all of plasticizers, stabilizers, fiber sizing, polymerization catalysts, coloring agents, nucleating agents, or the like can be included in the composite formulations. In one embodiment, any additional additives to the composite materials can be at least recyclable and non-toxic, and, in one embodiment, can be formed from renewable resources.

The various components of a polymeric composite material can be suitably combined prior to forming a polymeric structure. For instance, in one embodiment, the components can be melt or solution mixed in the formulation desired in a formed structure and then formed into pellets, beads, or the like suitable for delivery to a formation process. According to this particular embodiment, a product formation process can be quite simple, with little or no measuring or mixing of components necessary prior to the formation process (e.g., at the hopper).

In one particular embodiment, a chaotic mixing method such as that described in U.S. Pat. No. 6,770,340 to Zumbrunnen, et at can be used to combine the components of the polymeric composite. A chaotic mixing process can be used, for example, to provide the composite material with a particular and selective morphology with regard to the different phases to be combined in the mixing process, and in particular, with regard to the polymers, the fibrous reinforcement materials, and the inhibitory agents to be combined in the mixing process. For example, a chaotic mixing process can be utilized to form a composite material including one or more inhibitory agents concentrated at a predetermined location in the composite, so as to provide for a controlled release of the agents, for instance a timed-release of the agents from the composite as the polymeric component of the composite material degrades over time.

Following combination of the various components, the composite polymeric material can be formed into a desired article of manufacture via a low energy formation process.

One exemplary formation process can include providing the components of the composite materials to a product mold and forming the product via an in situ polymerization process. According to this method, the desired monomers or oligomers can be solution mixed or melt mixed in the presence of a catalyst and a cyclodextrin, and the polymer/CD inclusion complex can be formed in a single step in situ polymerization process. Additives such as reinforcement fibers, a nanoclay, naturally derived oil, and one or more inhibitory agents, can optionally be combined with the other components. In one embodiment, an in situ polymerization formation process can be carried out at ambient or only slightly elevated temperatures, for instance, less than about 50° C. Accordingly, the activity of additives can be maintained through the formation process, with little or no loss in activity.

In situ polymerization can be preferred in some embodiments due to the more favorable processing viscosity and degree of mixing that can be attained. For example, a monomer solution can describe a lower viscosity than a solution of the polymerized material. Accordingly, a reactive injection molding process can be utilized with a low viscosity monomer solution though the viscosity of the polymer is too high to be processed similarly. In addition, better interfacial mixing can occur by polymerization in situ in certain embodiments, and better interfacial mixing can in turn lead to better and more consistent mechanical performance of the final molded structure.

A formation process can include forming a polymeric structure from a polymeric melt, for instance in an extrusion molding process, an injection molding process or a blow molding process. For purposes of the present disclosure, injection molding processes include any molding process in which a polymeric melt is forced under pressure, for instance with a ram injector or a reciprocating screw, into a mold where it is shaped and cured. Blow molding processes can include any method in which a polymer can be shaped with the use of a fluid and then cured to form a product. Blow molding processes can include extrusion blow molding, injection blow molding, and stretch blow molding, injection stretch blow molding, and extrusion blow molding, as desired. Extrusion molding methods include those in which a melt is extruded from a die under pressure and cured to form the final product, e.g., a film or a fiber.

When considering processes that include forming a structure from a melt, polymeric structures can be formed utilizing less energy than previously known melt processes. For example, melts can be processed at temperatures about 100° F. lower than molding temperatures necessary for polymers such as polypropylene, polyvinlyl chloride, polyethylene, and the like. For instance, composite polymeric melts as disclosed herein can be molded at temperatures between about 170° C. to about 180° C., about 100° C. less than many fiberglass/polypropylene composites.

In one embodiment, a composite polymeric material as disclosed herein can be formed as a pliable or non-pliable container, and in one particular embodiment, a container suitable for holding and protecting environmentally sensitive materials such as biologically active materials including pharmaceuticals and nutraceuticals. For purposes of the present disclosure, the term ‘pharmaceutical’ is herein defined to encompass materials regulated by the United States government including, for example, drugs and other biologics. For purposes of the present disclosure, the term ‘nutraceutical’ is herein defined to refer to biologically active agents that are not necessarily regulated by the United States government including, for example, vitamins, dietary supplements, and the like.

FIG. 8A illustrates one embodiment of a product formation incorporating composite materials as disclosed herein. In this embodiment, a layer 800 can be formed from a material including one or more cyclodextrin/polymer inclusion complexes and a variety of additives that can be conjugated to an inclusion complex. Of course, as discussed previously, a composite can include additives, either monomeric or polymeric, that are blended with the other components of the material, and not all components of a composite material need be conjugated with a cyclodextrin. In the embodiment of FIG. 8A, a product can include a single layer of a composite material. A layer can be formed according to any suitable process and can be pliable or non-pliable, as desired. For instance, a single-layer product can be an extrusion blow molded material formed as a nonpliable container for liquid or solid materials. Optionally, a layer can be formed as an extruded film so as to be thin and more pliable, for instance in forming a fiber, a sack or a bag.

Formed structures incorporating the composite materials can include laminates including the disclosed composite materials as one or more layers of the laminate. For example, a laminate structure can include one or more layers formed of composite materials as herein described so as to provide particular inhibitory agents at predetermined locations in the laminate structure. Such an embodiment can, for instance, provide for a controlled release of the inhibitory agents, for instance a timed-release of an agent from the composite as the adjacent layers and the polymeric component of the composite material degrade over time. Barrier properties may also be increased by using a wax coating inside or outside of the vessel being utilized for spraying or dipping.

In another embodiment, a laminate can include an impermeable polymeric layer on a surface of the structure, e.g., on the interior surface of a container (e.g., bottle or jar) or package (e.g., blister pac for pills). In one particular embodiment, an extruded film formed from a composite polymeric material can form one or more layers of such a laminate structure. For example, an impermeable PLA-based film can form an interior layer of a container so as to, for instance, prevent leakage, degradation or evaporation of liquids that can be stored in the container. Such an embodiment may be particularly useful when considering the storage of alcohol-based liquids, for instance, nutraceuticals in the form of alcohol-based extracts or tinctures.

A product can include multiple layers, each of which can be formed of a composite material as described herein. Multiple layers of a structure can be coextruded, can be separately formed and then laminated to one another, or some combination thereof. For example, FIG. 8B illustrates a structure including a first layer 802 and a second layer 804, both of which are formed of a composite as described herein. The adjacent layers 802, 804 can be the same as one another or can differ from one another by one or more components. For instance, layer 802 can be designed as a barrier layer and can include a component such as a nanoclay that can decrease the water vapor transmission rate of the structure and layer 804 can be designed as an inner layer that is intended to contact the contents of the structure and can include one or more different components, such as an antimicrobial component. Of course, a second layer of a bilayer structure need not be formed of a composite material as disclosed herein, and can be formed of a second material as desired.

FIG. 8C illustrates another product structure as may be utilized. According to this embodiment, a composite material may form a first layer 806 of a structure, and this layer may be combined with other layers, 808, 810, that are of a different composition, i.e., these layers do not incorporate a polymer/CD inclusion complex as disclosed herein. For example, a structure can include an adhesive layer 808 and an outer layer 810 that can be a polymeric material, a fibrous textile material, a paper, or the like.

In another embodiment, a composite polymeric material as described herein can be included in a structure to contain and protect environmentally sensitive materials such as environmentally sensitive agricultural materials including processed or unprocessed crops. For example, a composite polymeric material can be melt processed to form a fiber or a yarns and the fibers or yarns can be further processed to form a fabric, for instance a woven, nonwoven, or knitted fabric, that can be utilized to protect and/or contain an environmentally sensitive material such as a recently harvested agricultural material or optionally a secondary product formed from the agricultural material.

The following examples will serve to further exemplify the nature of the invention but should not be construed as a limitation on the scope thereof

### Example 1

### Materials

Polylactide(PLA4000) was obtained from NatureWorks PLA. β-cyclodextrin (β-CD) was obtained from Sigma-Aldrich. PEG400 obtained from USB Corporation (OH, USA) was utilized as a plasticizer in the described formulations. Preparation of inclusion complex

Initially, β-CD was added to a solution of PLA at a molar ratio of 30:1 PLA: β-CD. The solution was stirred at 80° C. for 0.5 hour and then at ambient temperature of 4 hours. The resulting solution was centrifuged at 10000 rpm for 10 minutes, and the inclusion complexes (IC) were collected. The collected inclusion complexes were dried at 35° C. for 48 hours.

Wide angle X-ray Diffraction (WAXD)

The XRD studies were carried out using a Scintag XDS 2000 (Scintag Inc., Santa Clara, USA) with a germanium detector equipped with Scintag DMSNT Version 1.37 software. The samples were scanned from the start angle of 5° to the stop angle of 60° at step size 0.02° and preset time 0.5 s. It was observed that PLA-β-CD-IC induced large shifts in the WAXD signals of the PLA and β-CD, which clearly demonstrates the formation of an inclusion complex.

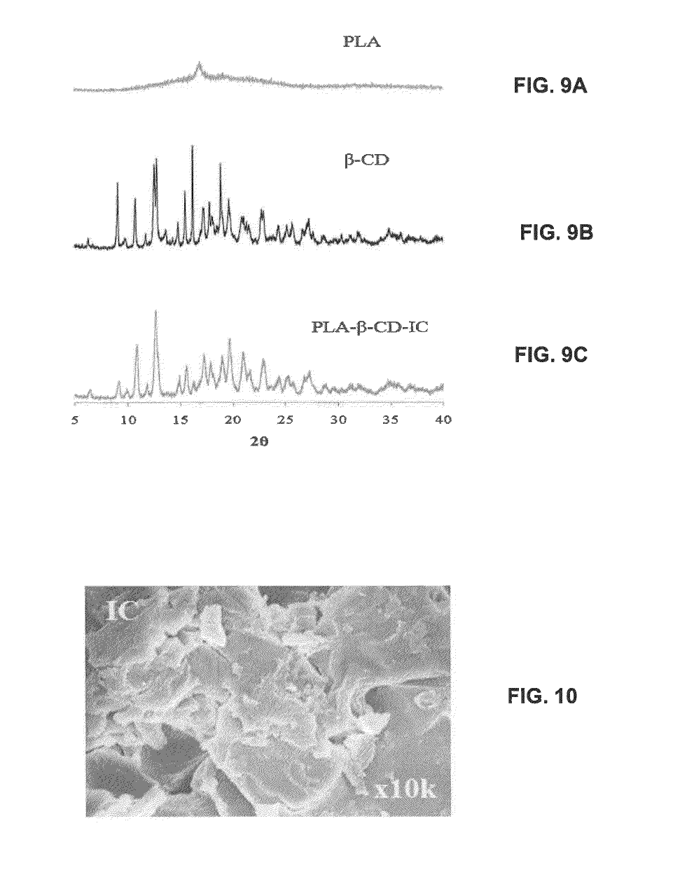

The results are shown in FIG. 9 include FIG. 9A showing PLA, FIG. 9B showing β-CD, and FIG. 9C showing the inclusion complex.

### Scanning Electron Microscopy (SEM)

The surface morphology of the PLA-β-CD-inclusion complex was examined by scanning electron microscopy (S-4800 UHR FE-SEM, Hitachi high technologies America, Inc.). Surfaces were prepared using platinum coating. The results are shown in FIG. 10.

### Thermal Processing

Melting temperatures (Tₘ) of the components and formed inclusion complex were also compared, with the pure PLA having a Tₘ of 164° C., the β-CD having a Tₘ of 290° C. and the inclusion complex having two Tₘ of 166° C. and 222°, providing additional evidence that the inclusion complex was formed.

### Example 2

A composite film was formed including the PLA/β-CD inclusion complex of Example 1. For comparison, other films were formed of a PLA/β-CD blend. Specifically, 15 g of PLA and 1.5 g PEG400 were dissolved in 100 mL methylene chloride. Either the inclusion complex (IC) or β-CD was added to the PLA solution and stirred for 12 hours.

To form the films, approximately 30 mL of solution was cast onto Teflon® coated glass plate using a film applicator. Following 2 hours drying, the formed films were peeled off of the glass and stored at ambient conditions.

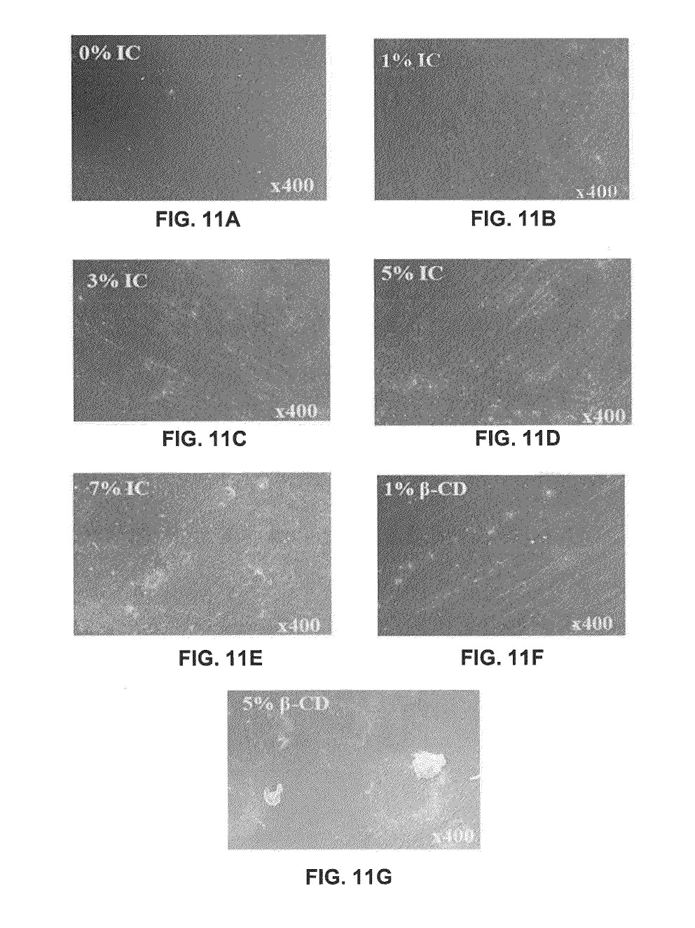

FIGS. 11A-11G are SEM images of the formed films include films incorporating the inclusion complex at 0%, 1%, 3%, 5%, and 7% by weight of the PLA polymer (FIGS. 11A-11E, respectively), and films incorporating the β-CD alone at 1% and 5% by weight of the PLA polymer (FIGS. 11F and 11G).

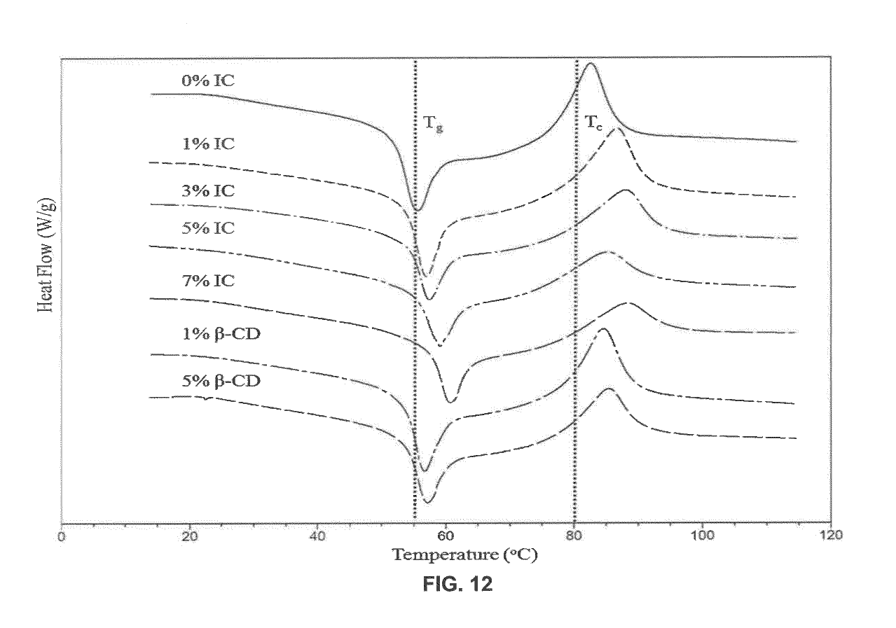

DSC thermograms of the control PLA film, PLA-β-CD-IC composite film (PLA-β-CD-IC-CFs), and PLA-β-CD composite films (PLA-β-CD-CFs) are depicted in FIG. 12. Thermal properties of the formed materials are shown in Table 1, below. Glass transition temperature (T_{g}) and crystallization temperature (T_{c}) of the PLA-IC-CFs tended to shift to higher temperature regions with an increasing IC content. This suggests that the crystallization rate of PLA was decreased in the presence of IC. The even dispersion of the ICs in PLA matrix may hinder the molecular mobility of the PLA chains. The crystallinity of PLA-IC-CFs decreased from 40.3 to 32.2% by addition of ICs from 0 to 7% (Table 1). It may result from the obstacle of crystal growth induced by the IC. Therefore, the crystallization rate and crystallinity of PLA-IC-CFs was decreased with an increasing IC content due to the delayed crystal growth and hindered molecular mobility of the PLA chains. In PLA-β-CD-CFS, T_{g} and T_{c} were increased and crystallinity was decreased with an increasing β-CD content. However, the effect of β-CD on those changes was less than that of IC.

TABLE 1

| | | | | | Crystallinity |
|---|---|---|---|---|---|
| | T_{g}(° C.) | T_{c}(° C.) | Tₘ(° C.) | ΔHₘ(Jg⁻¹) | (X_{c} %) |
| 0% IC | 56 | 83 | 164 | 39 | 40 |
| 1% IC | 57 | 87 | 164 | 34 | 36 |
| 3% IC | 58 | 88 | 164 | 31 | 33 |
| 5% IC | 59 | 85 | 164 | 31 | 33 |
| 7% IC | 61 | 88 | 165 | 30 | 32 |
| 1% β-CD | 57 | 85 | 164 | 34 | 36 |
| 5% β-CD | 57 | 86 | 164 | 32 | 34 |

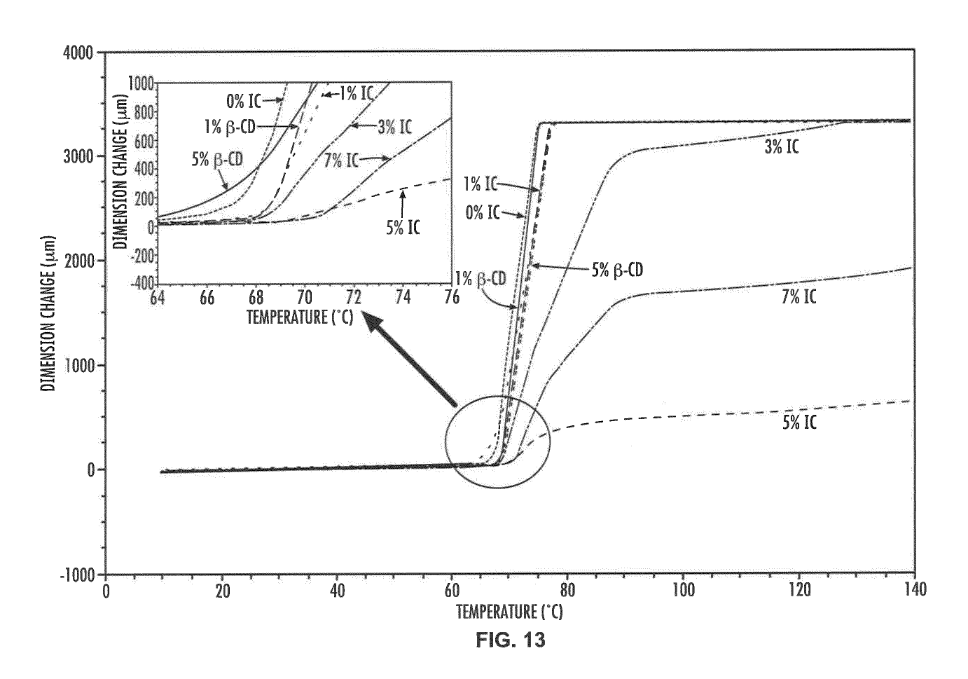

Thermomechanical analysis (TMA) was used to investigate the thermal stability of the control PLA film, the PLA-IC-CFs, and PLA-β-CD-CFs by measuring the behavior of dimensional change of the films (Table 2 and FIG. 13). While not wishing to be bound to any particular theory, it is believed that lower coefficient of expansion rate (slope), higher onset temperature, and less dimensional changes illustrate better thermal stability of the films. As can be seen, slopes of all PLA-IC-CFs were smaller than that of the control. Dimensional change of all films except for 3 to 7% PLA-IC-CFs reached to the maximum expansion limit of TMA instrument at around 79° C. Onset temperature of PLA-IC-CFs increased from 66.6 to 70.7° C. by increasing the amount of IC from 0 to 7%. The PLA-IC-CF containing IC content 3 to 7% had less dimensional changes than the control at the range of 20 to 80° C. The 5% PLA-IC-CF showed the lowest slope and dimensional changes. However, PLA-β-CD-CFs showed more dimensional changes compared with the control PLA film at the range of 20 to 80° C. Furthermore, 1% PLA-p-CD-CF had same slope and 5% PLA-βCD-CF had same onset temperature compared with the control PLA film. Therefore, 3 to 7% addition of IC is effective to improve the thermal stability of the PLA film and 5% addition of IC showed the best thermal stability of the film. Herein, the simple addition of β-CD blended into the film matrix did not improve thermal stability of the PLA/β-CD composite films.

TABLE 2

| | Slope | Onset | | | | Dimensional |
|---|---|---|---|---|---|---|
| | (μm/° C.) at | temp. | Accumulated Dimensional Change (%) | | | Change end |
| | 20-55° C. | (° C.) | 20-75° C. | 20-80° C. | 20-140° C. | Temp (° C.) |
| 0% IC | 0.81 | 67 | 43 | 43 | 43 | 75 |
| 1% IC | 0.54 | 68 | 43 | 55 | 55 | 77 |
| 3% IC | 0.60 | 68 | 19 | 28 | 49 | 130 |
| 5% IC | 0.50 | 69 | 5 | 7 | 10 | 139 |
| 7% IC | 0.64 | 71 | 10 | 16 | 28 | 139 |
| 1% β-CD | 0.82 | 69 | 45 | 46 | 46 | 75 |
| 5% β-CD | 0.63 | 67 | 35 | 47 | 47 | 77 |

While preferred embodiments of the disclosed subject matter have been described using specific terms, such description is for illustrative purposes only, and it is to be understood that changes and variations may be made without departing from the spirit or scope of the disclosure.

What is claimed:

1. A molded container for solid or liquid materials comprising a first layer, the first layer being a molded layer formed of a composite polymeric material, the composite polymeric material comprising a lactide-based polymer, a cyclodextrin, and an oil, fatty acid or waxy ester wherein the lactide-based polymer and the cyclodextrin of the molded first layer form an inclusion complex.

2. The molded container according to claim 1, wherein the container is injection molded or blow molded.

3. The molded container according to claim 1, wherein the first layer is an extruded layer.

4. The molded container according to claim 1, further comprising a second layer adjacent to the first layer.

5. The molded container of claim 4, wherein the second layer is formed of a composite polymeric material, the composite polymeric material of the second layer comprising a second polymer and a second cyclodextrin, wherein the second polymer and the second cyclodextrin of the molded second layer form an inclusion complex.

6. The molded container of claim 5, wherein the lactide-based polymer and the second polymer are the same polymers.

7. The molded container of claim 5, wherein the lactide-based polymer and the second polymer are different polymers.

8. The molded container of claim 4, wherein the second layer is a liquid impermeable polymeric layer.

9. The molded container of claim 1, wherein the composite polymeric material comprises more than about 50% by weight of the lactide-based polymer.

10. A method of forming a container comprising:
forming an inclusion complex between a cyclodextrin and a lactide-based polymer;
forming a composite polymeric material comprising the inclusion complex and an oil, fatty acid or waxy ester; and
molding the polymeric composite material to form the container.

11. The method according to claim 10, further comprising substituting a hydroxyl group of the cyclodextrin with a functional group to form a reactive moiety on the cyclodextrin.

12. The method according to claim 11, further comprising conjugating the cyclodextrin at the reactive moiety with a component of the polymeric composite material.

13. The method according to claim 12, wherein the cyclodextrin and the component are conjugated via a cross linking agent.

14. The method according to claim 10, wherein the inclusion complex is formed in a one-step process that includes in situ polymerization of the polymer in the presence of the cyclodextrin.

15. The method according to claim 10, wherein the polymeric composite material is injection molded or blow molded.

16. The method according to claim 10, wherein the polymeric composite material is molded via extrusion.

17. The method according to claim 10, wherein the polymeric composite material is molded at a temperature between about 170° C. and about 180° C.
